(19) United States
(12) Patent Application Publication
(10) Pub. No.: US 2024/0202559 A1
(43) Pub. Date: Jun. 20, 2024

(54) REDUCING NUMBER OF SHOTS REQUIRED TO PERFORM A NOISY CIRCUIT SIMULATION

(71) Applicant: International Business Machines Corporation, Armonk, NY (US)

(72) Inventors: Jun Doi, Yokohama-shi (JP); Hiroshi Horii, Tokyo (JP)

(21) Appl. No.: 18/082,510

(22) Filed: Dec. 15, 2022

(51) Int. Cl. G06N 10/20

(52) U.S. Cl. CPC G06N 10/20

(57) ABSTRACT

A method, system and computer program product for reducing the number of shots required to perform a noisy circuit simulation. A noise model, such as the Pauli noise model or the Kraus noise model, is applied to each shot of the quantum circuit, where the noise model randomly selects a gate operation to be performed in simulating the quantum circuit. A subset of shots are identified (e.g., shot numbers 1 and 3), where each of the selected subset of shots has the same gate operation(s) selected by the noise model to be performed in simulating the quantum circuit. A single simulation of the quantum circuit will then be performed for such a subset of shots using the selected gate operation (e.g., Pauli Z gate) for such a group of shots. In this manner, the number of shots required to perform a noisy circuit simulation is reduced.

### TECHNICAL FIELD

The present disclosure relates generally to noisy circuit simulations in quantum computing, and more particularly to reducing the number of shots required to perform a noisy circuit simulation by performing a single simulation of the quantum circuit for multiple shots using the same gate operation(s) on the qubits of the quantum circuit which were selected by the noise model for the multiple shots.

### BACKGROUND

Quantum computing is a type of computation that harnesses the collective properties of quantum states, such as superposition, interference, and entanglement, to perform calculations. The devices that perform quantum computations are known as quantum computers. Though current quantum computers are too small to outperform usual (classical) computers for practical applications, they are believed to be capable of solving certain computational problems, such as integer factorization, substantially faster than classical computers.

### SUMMARY

In one embodiment of the present disclosure, a method for reducing a number of shots required to perform a noisy circuit simulation comprises applying a noise model to each shot of a plurality of shots of a quantum circuit which randomly selects a gate operation to be performed in simulating the quantum circuit. The method further comprises identifying a subset of the plurality of shots with a selection of a same gate operation. The method additionally comprises performing a single simulation of the quantum circuit for the identified subset of the plurality of shots using the same gate operation.

Other forms of the embodiment of the method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical system for reducing the number of shots required to perform a noisy circuit simulation in accordance with an embodiment of the present disclosure;

FIG. 3 illustrates creating a new statevector for each identified subset of shots which has the same gate operation(s) selected by the noise model to be performed in simulating the quantum circuit in accordance with an embodiment of the present disclosure;

FIG. 4 illustrates handling the situation when there is not enough memory to store a new statevector in accordance with an embodiment of the present disclosure;

FIG. 5 illustrates an embodiment of the present disclosure of the hardware configuration of the classical computer which is representative of a hardware environment for practicing the present disclosure; and

FIG. 6 is a flowchart of a method for reducing the number of shots required to perform a noisy circuit simulation in accordance with an embodiment of the present disclosure.

### DETAILED DESCRIPTION

As stated in the Background section, quantum computing is a type of computation that harnesses the collective properties of quantum states, such as superposition, interference, and entanglement, to perform calculations. The devices that perform quantum computations are known as quantum computers. Though current quantum computers are too small to outperform usual (classical) computers for practical applications, they are believed to be capable of solving certain computational problems, such as integer factorization, substantially faster than classical computers.

There are several types of quantum computers (also known as quantum computing systems), including the quantum circuit model, quantum Turing machine, adiabatic quantum computer, one-way quantum computer, and various quantum cellular automata. The most widely used model is the quantum circuit, based on the quantum bit, or “qubit,” which is somewhat analogous to the bit in classical computation. A qubit can be in a 1 or 0 quantum state, or in a superposition of the 1 and 0 states. When the state of the qubit is measured from the execution of the quantum circuit, however, it is always 0 or 1 where the probability of either outcome depends on the qubit's quantum state immediately prior to measurement.

Unfortunately, quantum devices, such as quantum circuits, are susceptible to errors. In particular, the qubit measurement is among the most error-prone operations on quantum devices, with error rates ranging from 8% to 30% for current hardware. These errors arise from bit flips, i.e., from erroneously recording an outcome as 0 given it was actually 1, and vice-versa. The source of such errors arise from noise that occurs throughout a computation.

Noise refers to the multiple factors that can affect the accuracy of the calculations a quantum computer performs. Quantum computers are susceptible to noise from various sources, such as disturbances in the Earth's magnetic field, local radiation from Wi-Fi or mobile phones, cosmic rays, and even the influence that neighboring qubits exert on each other by mere proximity. These disruptions cause the information an idle qubit holds to fade away. Lastly, when performing a quantum logic operation, qubits can also suffer from errors that cause them to rotate by the wrong amount. In all cases, the final state of the quantum computer is not precisely the state one expects. Unless one can reverse the action of the noise, the information in the quantum system can become randomized or totally erased. This phenomenon is known as decoherence.

As a result, noise models have been constructed to approximate the real behavior of the quantum device taking into consideration such noise effects, such as gate noise, readout noise, etc. Examples of such noise models include the Pauli noise and Kraus noise models.

Subsequently, quantum circuits are simulated with noise models in order to consider the noise on the actual hardware or to understand the behavior of noisy hardware.

Unfortunately, such noise models require simulations of a quantum circuit involving a large number of shots. A “shot” corresponds to one complete execution of a quantum circuit. A quantum circuit is a computational routine consisting of coherent quantum operations on quantum data, such as qubits. Simulations of a quantum circuit involving a large number of shots are required by such noise models as the calculated statevectors for each shot after completion of the shot are varied due to quantum errors. A “statevector” corresponds to a format of the state of probabilities (e.g., quantum state of 1 or quantum state of 0) for the qubits manipulated by the quantum logic gates of the quantum circuit. A “quantum logic gate” corresponds to a basic quantum circuit operating on a small number of qubits. Quantum logic gates are the building blocks of quantum circuits.

Furthermore, intermediate measurements, which correspond to measurements taking during the shot, are used to evaluate a qubit state in the quantum circuit for branch operations. Such measurements also cause different results per shot due to noise. As a result, simulations involving intermediate measurements also require a large number of shots.

By requiring simulations of a quantum circuit involving a large number of shots, such simulations require a large amount of computing time and computing resources.

The embodiments of the present disclosure provide the means for reducing the number of shots required to perform a noisy circuit simulation by performing a single simulation of the quantum circuit for multiple shots using the same gate operation selected by the noise model for such shots as discussed in further detail below.

In some embodiments of the present disclosure, the present disclosure comprises a method, system and computer program product for reducing the number of shots required to perform a noisy circuit simulation. In one embodiment of the present disclosure, a noise model, such as the Pauli noise model or the Kraus noise model, is applied to each shot of the quantum circuit to be simulated, where the noise model randomly selects a gate operation to be performed in simulating the quantum circuit. A “shot,” as used herein, corresponds to one complete execution of a quantum circuit. For example, the Pauli noise model randomly selects particular quantum logic gates (e.g., identity (“ID”) gate and the Pauli gates (X, Y and Z gates)) to perform gate operations on the qubits of the simulated quantum circuit based on a probability table. It has been discovered that in a large number of cases, the identity gate is selected. When the same gate operations are performed by the same simulated quantum circuit, even for different shots, the simulated quantum circuit produces results (measured quantum states of the qubits of the simulated quantum circuit) that are relatively the same. Hence, the number of shots required to perform a noisy circuit simulation can be reduced by simulating a quantum circuit to perform the gate operations on the qubits of the quantum circuit for a single shot that represents other shots in cases where the noise model selects the same gate operations to be performed by the simulated quantum circuit for such shots. Similarly, in another example, the Krause noise model selects matrix multiplications to be performed by the simulated quantum circuit based on a probability table. It has been discovered that in a large number of cases, the first matrix is selected, which is equivalent to the identity gate. Hence, as in the case with the Pauli noise model, the number of shots required to perform a noisy circuit simulation can be reduced by simulating a quantum circuit to perform the gate operations on the qubits of the quantum circuit for a single shot that represents other shots in cases where the noise model selects the same matrix multiplications (gate operations) to be performed by the simulated quantum circuit for such shots. In one embodiment, a subset of shots are identified, where each of the identified subset of shots has the same gate operation(s) selected by the noise model to be performed in simulating the quantum circuit. For example, shot numbers 1 and 3 may be identified as having the same gate operation (Pauli Z gate) selected by the noise model to be performed in simulating the quantum circuit. A single simulation of the quantum circuit would then be performed for such a subset of shots using the gate operation (e.g., Pauli Z gate) selected by the noise model for such a group of shots. Since the results (measured quantum states of the qubits of the simulated quantum circuit) in simulating the quantum circuit by performing the same gate operations, even for different shots, are relatively the same, the number of shot calculations can be reduced by only performing the gate operations on the qubits of the quantum circuit for a single shot that represents other shots in the same grouping of shots where the noise model selects the same gate operations to be performed by the quantum circuit to be simulated. In this manner, the number of shots required to perform a noisy circuit simulation is reduced.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

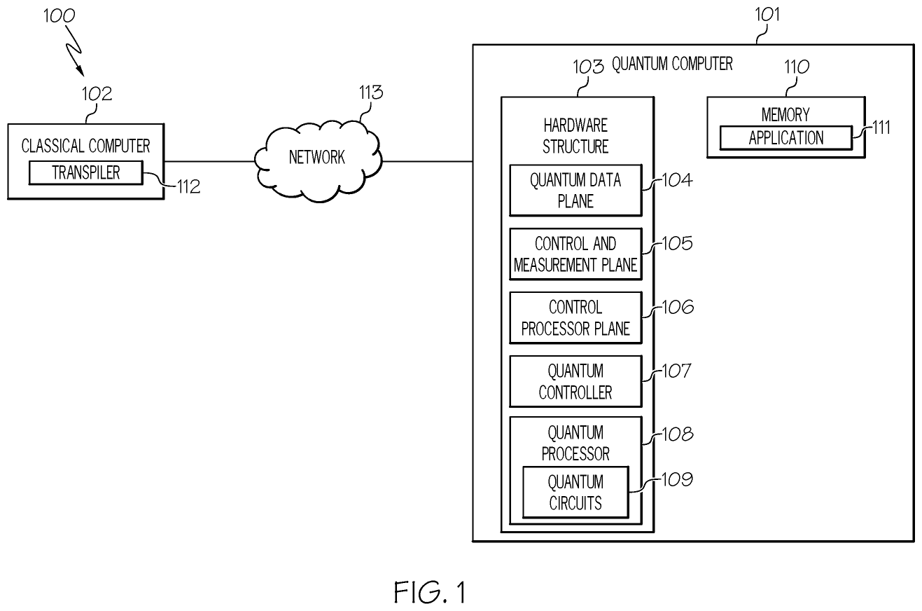

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference and entanglement, as well as a classical computer 102 in which information is stored in bits that are represented logically by either a 0 (off) or a 1 (on). Examples of classical computer 102 include, but not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to setup the state of quantum bits in quantum computer 101 and then quantum computer 101 starts the quantum process. Furthermore, in one embodiment, classical computer 102 is configured to reduce the number of shots required to perform a noisy circuit simulation by performing a single simulation of the quantum circuit for multiple shots using the same gate operation(s) selected by the noise model for such shots as discussed further below.

In one embodiment, a hardware structure 103 of quantum computer 101 includes a quantum data plane 104, a control and measurement plane 105, a control processor plane 106, a quantum controller 107 and a quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gate, are all reversible. Examples of quantum logic gates include RX (performs e^{jθX}, which corresponds to a rotation of the qubit state around the X-axis by the given angle theta θ on the Bloch sphere), RY (performs e^{jθY}, which corresponds to a rotation of the qubit state around the Y-axis by the given angle theta θ on the Bloch sphere), RXX (performs the operation e^{(-iθ/2X⊕X)} on the input qubit), RZZ (takes in one input, an angle theta θ expressed in radians, and it acts on two qubits), etc. In one embodiment, quantum circuits 109 are written such that the horizontal axis is time, starting at the left hand side and ending at the right hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

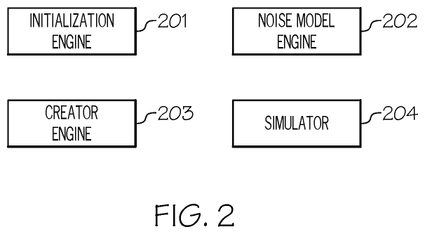

In one embodiment, memory 110 stores an application 111 that may be configured to implement one or more of the methods described herein in accordance with one or more embodiments. For example, application 111 may implement a program for reducing the number of shots required to perform a noisy circuit simulation by performing a single simulation of the quantum circuit for multiple shots using the same gate operation(s) selected by the noise model for such shots as discussed further below in connection with FIGS. 2-6. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses and algorithms) converts the trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to setup the state of quantum bits in quantum computer 101, may be connected to quantum computer 101 via a network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

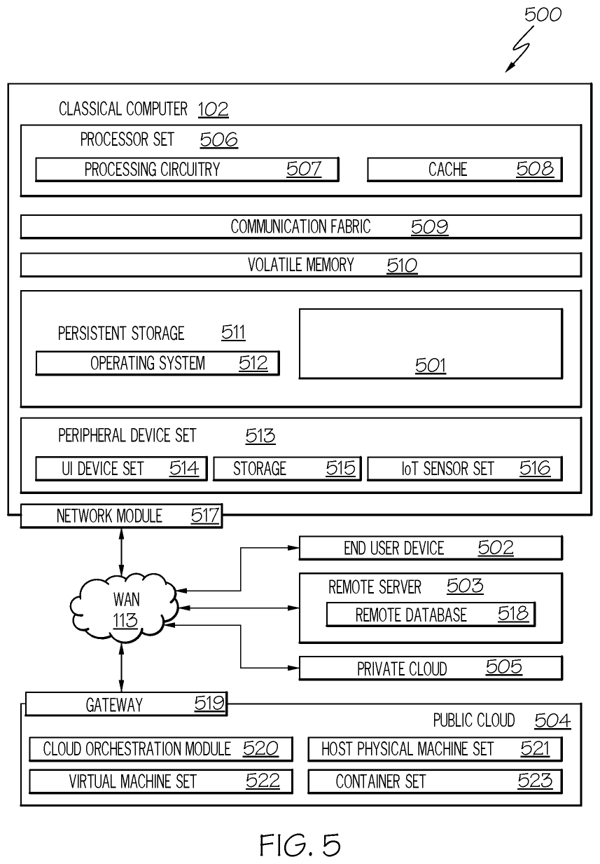

Furthermore, classical computer 102 is configured to reduce the number of shots required to perform a noisy circuit simulation by performing a single simulation of the quantum circuit for multiple shots using the same gate operation(s) selected by the noise model for such shots as discussed further below in connection with FIGS. 2-6. A description of the software components of classical computer 102 is provided below in connection with FIG. 2 and a description of the hardware configuration of classical computer 102 is provided further below in connection with FIG. 5.

System 100 is not to be limited in scope to any one particular network architecture. System 100 may include any number of quantum computers 101, classical computers 102 and networks 113.

A discussion regarding the software components used by classical computer 102 for reducing the number of shots required to perform a noisy circuit simulation is provided below in connection with FIG. 2.

FIG. 2 is a diagram of the software components of classical system 102 (FIG. 1) for reducing the number of shots required to perform a noisy circuit simulation in accordance with an embodiment of the present disclosure.

Referring to FIG. 2, in conjunction with FIG. 1, classical computer 102 includes an initialization engine 201 configured to initialize a statevector with a listing of the shots to be calculated from simulating a quantum circuit. A “statevector,” as used herein, refers to a vector that holds the information needed to describe the measured quantum state of a simulated quantum circuit. In one embodiment, the statevector holds such information for each particular shot. A “shot,” as used herein, corresponds to one complete execution of a quantum circuit. In one embodiment, when initialization engine 201 initializes the statevector, the statevector only includes a listing of the shots to be calculated, such as shot numbers 0 . . . n−1, where n is a positive integer number.

In one embodiment, initialization engine 201 initializes the statevector as discussed above using the class initialize in Qiskit®, in which the parameters of the statevector are initialized to include a listing of the shots to be calculated.

Classical computer 102 further includes a noise model engine 202 configured to apply a noise model (e.g., Pauli noise model, Krause noise model) to each shot identified in the list of shots to be calculated discussed above. As discussed in further detail below, for each shot, the noise model randomly selects a gate operation(s) to be performed in simulating the quantum circuit, such as quantum circuit 109, for such a shot.

For example, noise models, such as the Pauli noise model and the Kraus noise model, select gate operations to be performed by the quantum circuit to be simulated. In one embodiment, such gate operations are randomly selected. For example, the Pauli noise model randomly selects particular quantum logic gates (e.g., identity (“ID”) gate and the Pauli gates (X, Y and Z gates)) to perform gate operations on the qubits of the simulated quantum circuit based on a probability table. It has been discovered that in a large number of cases, the identity gate is selected. When the same gate operations are performed by the same simulated quantum circuit, even for different shots, the simulated quantum circuit produces results (measured quantum states of the qubits of the simulated quantum circuit) that are relatively the same. Hence, the number of shots required to perform a noisy circuit simulation can be reduced by simulating a quantum circuit to perform the gate operations on the qubits of the quantum circuit for a single shot that represents other shots in cases where the noise model selects the same gate operations to be performed by the quantum circuit to be simulated for such shots.

Similarly, in another example, the Krause noise model selects matrix multiplications to be performed by the quantum circuit to be simulated based on a probability table. It has been discovered that in a large number of cases, the first matrix is selected, which is equivalent to the identity gate. Hence, as in the case with the Pauli noise model, the number of shots required to perform a noisy circuit simulation can be reduced by simulating a quantum circuit to perform the gate operations on the qubits of the quantum circuit for a single shot that represents other shots in cases where the noise model selects the same matrix multiplications (gate operations) to be performed by the quantum circuit to be simulated for such shots.

In one embodiment, noise model engine 202 applies such noise models to each shot identified in the list of shots to be calculated discussed above using various software tools, including, but not limited to, Cirq, QuTIP, Qiskit® Aer Simulator, etc.

In one embodiment, noise model engine 202 identifies the subsets of shots (e.g., shot numbers 1 and 3 in one set, shot numbers 5, 6 and 7 in another set, etc.) out of the listing of shots to be calculated, where each identified subset of shots has the same gate operation(s) selected by the noise model to be performed in simulating the quantum circuit, such as quantum circuit 109. For example, shot numbers 1 and 3 may be identified as having the same gate operation (Pauli Z gate) selected by the noise model to be performed in simulating the quantum circuit. A single simulation of the quantum circuit would then be performed for such a subset of shots using the gate operation (e.g., Pauli Z gate) selected by the noise model for such a group of shots. Since the results (measured quantum states of the qubits of the simulated quantum circuit) in simulating the quantum circuit by performing the same gate operations, even for different shots, are relatively the same, the number of shot calculations can be reduced by only performing the gate operations on the qubits of the quantum circuit for a single shot that represents other shots in the same grouping of shots where the noise model selects the same gate operations to be performed by the quantum circuit to be simulated for such shots.

In one embodiment, noise model engine 202 identifies such subsets of shots (e.g., shot numbers 1 and 3 in one set, shot numbers 5, 6 and 7 in another set, etc.) out of the listing of shots to be calculated, where each identified subset of shots has the same gate operation(s) selected by the noise model to be performed in simulating the quantum circuit, such as quantum circuit 109, using various software tools, including, but not limited to, Qiskit® Aer Simulator, True-Q™, etc.

Classical computer 102 further includes a creator engine 203 configured to create a new statevector for each identified subset of shots. In one embodiment, such a created statevector corresponds to a copy of the initialized statevector except that the listing of shots corresponds to only those shot numbers in the identified subset of shots. For example, if noise model engine 202 identifies shot numbers 1 and 3 as having the same gate operation (Pauli Z gate) selected by the noise model to be performed in simulating the quantum circuit, then creator engine 203 creates a new statevector for such a grouping of shots, where such a new statevector includes a listing of shot numbers 1 and 3.

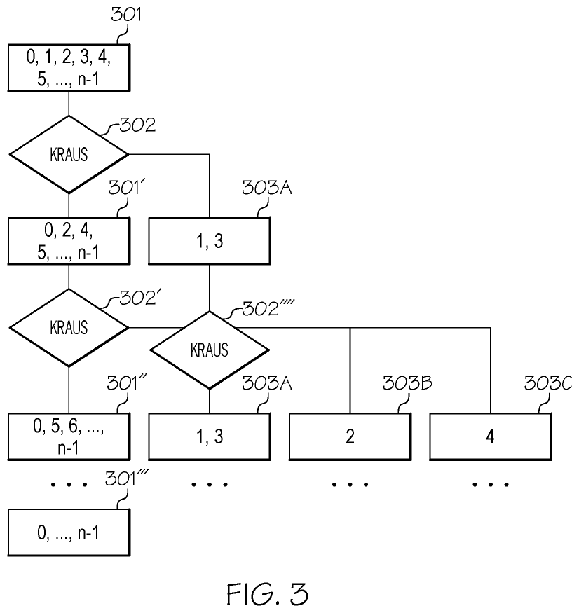

For example, as shown in FIG. 3, FIG. 3 illustrates creating a new statevector for each identified subset of shots which has the same gate operation(s) selected by the noise model to be performed in simulating the quantum circuit in accordance with an embodiment of the present disclosure.

Referring to FIG. 3, as discussed above, initialization engine 201 initializes a statevector 301 with a listing of the shots (shot numbers 0 . . . , n−1), where n is a positive integer, to be calculated. Furthermore, as discussed above, noise model engine 202 applies a noise model, such as noise model 302 (e.g., Pauli noise model, Krause noise model), to each shot identified in the list of shots to be calculated. For each shot, noise model 302 selects a gate operation to be performed in simulating the quantum circuit, such as quantum circuit 109, for such a shot.

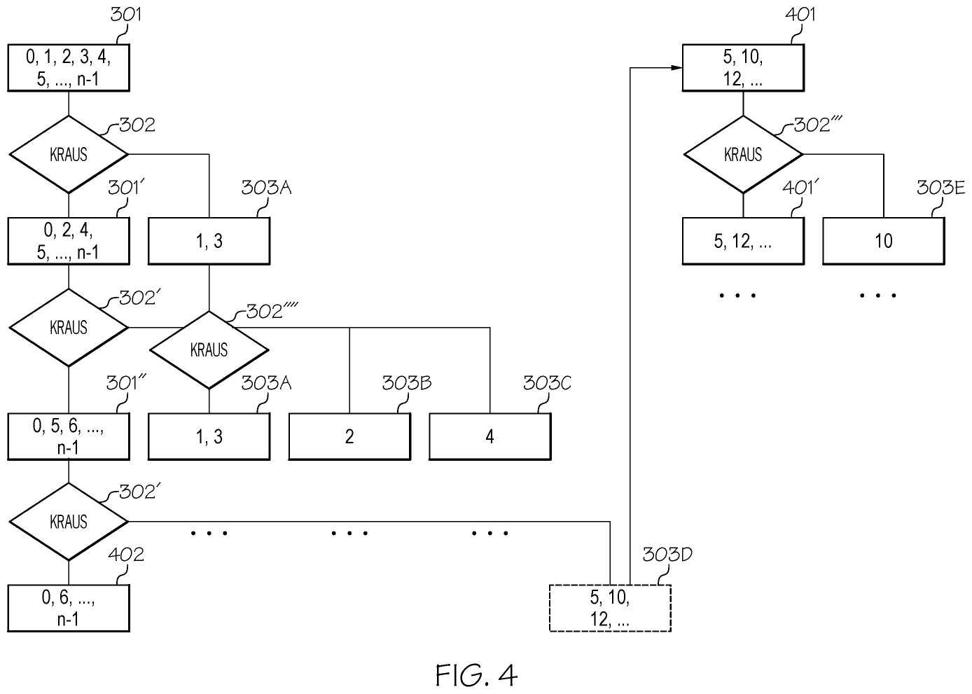

For instance, as shown in FIG. 3, noise model engine 202 applies noise model 302 to each shot listed in the initialized statevector 301 where noise model 302 randomly selects a gate operation(s) to be performed in simulating the quantum circuit, such as quantum circuit 109. It is noted that noise model 302 may also be identified as 302′, 302″, 302′″ and 302″″ in FIGS. 3 and 4 as discussed herein. Any reference to noise model 302 herein also applies to noise models 302′, 302″, 302′″ and 302″″.

As discussed above, noise model engine 202 identifies the subsets of shots (e.g., shot numbers 1 and 3 in one set, shot numbers 5, 6 and 7 in another set, etc.) out of the listing of shots to be calculated which have the same gate operation(s) selected by the noise model to be performed in simulating the quantum circuit, such as quantum circuit 109. For instance, as shown in FIG. 3, shot numbers 1 and 3 were identified by noise model engine 202 as having the same gate operation(s) (e.g., identity gate) selected by noise model 302 to be performed in simulating the quantum circuit, such as quantum circuit 109. As a result, a new statevector 303A is created by creator engine 203 copying statevector 301 and applying gate operations selected by noise model 302. As shown in FIG. 3, statevector 303A includes the listing of shot numbers 1 and 3. Such shots are known as “branched shots” since the listing of such shots are branched from the original listing of shots in the initialized statevector 301 as shown in FIG. 3. Furthermore, as a result of creating a new statevector, such as statevector 303A, for the branched shots (e.g., shot numbers 1 and 3), the original listing of shots in the initialized statevector 301 is updated to reflect that a portion of the shots in the original listing of shots have been branched, such as removing such shots from the original listing of shots as shown in statevector 301′ (updated statevector 301 of FIG. 3).

Furthermore, FIG. 3 illustrates other branched shots, such as shot number 2 and shot number 4. For instance, noise model engine 202 identifies shot number 2 out of the listing of shots to be calculated as corresponding to the only shot in which a particular gate operation (e.g., Pauli X gate) was selected by noise model 302′ (same as noise model 302) to be performed in simulating the quantum circuit, such as quantum circuit 109. In such a case, a new statevector 303B is created by creator engine 203 which includes the listing of shot number 2. In another example, noise model engine 202 identifies shot number 4 out of the listing of shots to be calculated as corresponding to the only shot in which a particular gate operation (e.g., Pauli Y gate) was selected by noise model 302′ (same as noise model 302) to be performed in simulating the quantum circuit, such as quantum circuit 109. In such a case, a new statevector 303C is created by creator engine 203 which includes the listing of shot number 4.

As a result of creating statevectors 303B, 303C for the branched shots (e.g., shot numbers 2 and 4, respectively), the original listing of shots in the initialized statevector 301 is updated to reflect that a portion of the shot numbers in the original listing of shots have been branched, such as removing such shots from the original listing of shots as shown in statevector 301″ (updated statevector 301′ of FIG. 3).

New statevectors, such as statevectors 303A-303E (statevectors 303D, 303E are discussed further below), are created for each unique gate operation(s) (including a set of gate operations) selected by noise model 302 for the shot(s) associated with such statevectors 303. New statevectors 303A-303E may collectively or individually be referred to as statevectors 303 or statevector 303. While FIG. 3 illustrates three new statevectors 303, embodiments of the present disclosure may create any number of new statevectors 303 corresponding to the number of unique gate operations (including a set of gate operations) selected by noise model 302 for the shot(s) associated with such statevectors 303.

As a result of such branched shots, the initialized statevector 301 is updated to reflect those particular shot numbers in the original listing of shots that have been branched, such as removing such shots from the original listing of shots as shown in statevector 301′″, which reflects the final listing of shots for the original initialized statevector 301.

In one embodiment, creator engine 203 determines whether there is enough memory in classical computer 102 to store the created statevector(s) 303. If there is enough memory in classical computer 102 to store such created statevector(s) 303, then such created statevector(s) 303 are stored in memory of classical computer 102. If, on the other hand, there is not enough memory in classical computer 102 to store such a created statevector(s) 303, then creator engine 203 stores the listing of shots associated with such a created statevector(s) 303 in an out of memory list, such as in a storage device of classical computer 102. For example, as shown in FIG. 4, FIG. 4 illustrates handling the situation when there is not enough memory to store a new statevector 303 in accordance with an embodiment of the present disclosure.

Referring to FIG. 4, in conjunction with FIGS. 1-3, noise model engine 202 identifies shot numbers 5, 10, 12 . . . out of the listing of shots to be calculated as corresponding to those shots in which a particular gate operation (e.g., Pauli Z gate) was selected by noise model 302″ (same as noise model 302) to be performed in simulating the quantum circuit, such as quantum circuit 109. In such a case, a new statevector 303D is created by creator engine 203 which includes the listing of shot numbers 5, 10, 12, etc. In such a case, however, there is not enough memory to store such a statevector. Hence, creator engine 203 stores a listing of the shots 401 associated with statevector 303D in an out of memory list, such as in a storage device of classical computer 102. Upon storing such a listing of shots 401 in an out of memory list, the original listing of shots in the initialized statevector 301 is updated to reflect that a portion of the shots in the original listing of shots have been branched, such as removing shots 5, 10, 12, etc. from the original listing of shots as shown in statevector 402.

In one embodiment, when there is enough memory to store such newly created statevectors 303 (e.g., statevector 303D), the process discussed above is performed in the same manner except that the initialized statevector 301 corresponds to the listing of shots in listing 401. That is, listing 401 corresponds to a statevector with a listing of shots to be calculated. The process then proceeds as discussed above, such as applying noise model 302′″ (same as noise model 302) to each shot in listing 401, which results in noise model engine 202 identifying shot number 10 out of the listing of shots in listing 401 to be the only shot out of the shots listed in listing 401 in which a particular gate operation (e.g., Pauli X gate) was selected by noise model 302′″ to be performed in simulating the quantum circuit, such as quantum circuit 109. In such a case, a new statevector 303E is created by creator engine 203 which includes the listing of shot number 10. As a result of creating statevector 303E for the branched shot (e.g., shot number 10), the original listing 401 is updated to reflect that a portion of the shots in the original listing has been branched, such as removing such a shot from the original listing of shots as shown in listing 401′ (updated listing 401 of FIG. 4).

As discussed above, if there is enough memory in classical computer 102 to store such created statevector(s) 303, then such created statevector(s) 303 are stored in memory of classical computer 102.

Returning to FIG. 3, in conjunction with FIGS. 1-2, upon storing the created statevector(s) 303, such as statevector 303A, a single simulation of the quantum circuit, such as quantum circuit 109, is performed by a simulator 204 of classical computer 102 for the identified subset of shots using the same gate operation(s) selected by noise model 302 for such shots. For example, simulator 204 may simulate the quantum circuit, such as quantum circuit 109, using the same gate operation(s) selected by noise model 302″″ (same as noise model 302) for each of the identified subset of shots (e.g., shot numbers 1 and 3).

In one embodiment, simulator 204 measures the quantum states of the qubits of the simulated quantum circuit for the identified subset of shots after performing the single simulation. Such measured quantum states of the qubits are stored in the statevector 303 (e.g., statevector 303A) associated with such a subset of shots by updating such a statevector 303 to include the measured quantum states of the qubits of the simulated quantum circuit.

In one embodiment, simulator 204 measures the quantum states of the qubits of the simulated quantum circuit, such as quantum circuit 109, for multiple branched shots concurrently, which improves efficiency of kernel execution.

Furthermore, in one embodiment, by simulator 204 measuring the quantum states of the qubits of the simulated quantum circuit, such as quantum circuit 109, for branched shots, intermediate measurements may be handled. For example, intermediate measurement may be used to evaluate a qubit state in the quantum circuit, such as quantum circuit 109, for branch operations that also cause a different result per shot.

In one embodiment, upon simulator 204 measuring the quantum state of the qubits of the simulated quantum circuit, such as quantum circuit 109, for the identified subset of shots, simulator 204 updates statevector 303 associated with the identified subset of shots (e.g., shot numbers 1 and 3) with the measured quantum states of the qubits of the simulated quantum circuit, such as quantum circuit 109. For example, statevector 303 (e.g., statevector 303A) with the listing of shot numbers 1 and 3 would also include the measured quantum states (e.g., 0 or 1) for the various qubits (e.g., qubits 0-9) of the simulated quantum circuit, such as quantum circuit 109, for shot numbers 1 and 3.

In one embodiment, examples of simulator 204 performing such functions, include, but not limited to, Qiskit® Aer simulator, IQS, staq, QuEST®, QX Simulator, QMDD, CHP, etc.

Conventional simulations using a noise model, such as noise model 302, require n statevector updates for n shot simulations in which n shots are measured independently. However, using the principles of the present disclosure, fewer than n shots need to be measured since a subset of the n shots may be grouped together to be associated with a single statevector, such as statevector 303, which includes a single simulation result (measured quantum states of the qubits of the simulated quantum circuit) applicable to all such grouped shots.

A further description of these and other functions is provided below in connection with the discussion of the method for reducing the number of shots required to perform a noisy circuit simulation.

Prior to the discussion of the method for reducing the number of shots required to perform a noisy circuit simulation, a description of the hardware configuration of classical computer 102 (FIG. 1) is provided below in connection with FIG. 5.

Referring now to FIG. 5, in conjunction with FIG. 1, FIG. 5 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code (stored in block 501) involved in performing the inventive methods, such as reducing the number of shots required to perform a noisy circuit simulation. In addition to block 501, computing environment 500 includes, for example, classical computer 102, network 113, such as a wide area network (WAN), end user device (EUD) 502, remote server 503, public cloud 504, and private cloud 505. In this embodiment, classical computer 102 includes processor set 506 (including processing circuitry 507 and cache 508), communication fabric 509, volatile memory 510, persistent storage 511 (including operating system 512 and block 501, as identified above), peripheral device set 513 (including user interface (UI) device set 514, storage 515, and Internet of Things (IoT) sensor set 516), and network module 517. Remote server 503 includes remote database 518. Public cloud 504 includes gateway 519, cloud orchestration module 520, host physical machine set 521, virtual machine set 522, and container set 523.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 518. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically classical computer 102, to keep the presentation as simple as possible. Classical computer 102 may be located in a cloud, even though it is not shown in a cloud in FIG. 5. On the other hand, classical computer 102 is not required to be in a cloud except to any extent as may be affirmatively indicated.

Processor set 506 includes one, or more, computer processors of any type now known or to be developed in the future. Processing circuitry 507 may be distributed over multiple packages, for example, multiple, coordinated integrated circuit chips. Processing circuitry 507 may implement multiple processor threads and/or multiple processor cores. Cache 508 is memory that is located in the processor chip package(s) and is typically used for data or code that should be available for rapid access by the threads or cores running on processor set 506. Cache memories are typically organized into multiple levels depending upon relative proximity to the processing circuitry. Alternatively, some, or all, of the cache for the processor set may be located “off chip.” In some computing environments, processor set 506 may be designed for working with qubits and performing quantum computing.

Computer readable program instructions are typically loaded onto classical computer 102 to cause a series of operational steps to be performed by processor set 506 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 508 and the other storage media discussed below. The program instructions, and associated data, are accessed by processor set 506 to control and direct performance of the inventive methods. In computing environment 500, at least some of the instructions for performing the inventive methods may be stored in block 501 in persistent storage 511.

Communication fabric 509 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 510 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 510 is located in a single package and is internal to classical computer 102, but, alternatively or additionally, the volatile memory may be distributed over multiple packages and/or located externally with respect to classical computer 102.

Persistent Storage 511 is any form of non-volatile storage for computers that is now known or to be developed in the future. The non-volatility of this storage means that the stored data is maintained regardless of whether power is being supplied to classical computer 102 and/or directly to persistent storage 511. Persistent storage 511 may be a read only memory (ROM), but typically at least a portion of the persistent storage allows writing of data, deletion of data and re-writing of data. Some familiar forms of persistent storage include magnetic disks and solid state storage devices. Operating system 512 may take several forms, such as various known proprietary operating systems or open source Portable Operating System Interface type operating systems that employ a kernel. The code included in block 501 typically includes at least some of the computer code involved in performing the inventive methods.

Peripheral device set 513 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 514 may include components such as a display screen, speaker, microphone, wearable devices (such as goggles and smart watches), keyboard, mouse, printer, touchpad, game controllers, and haptic devices. Storage 515 is external storage, such as an external hard drive, or insertable storage, such as an SD card. Storage 515 may be persistent and/or volatile. In some embodiments, storage 515 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 516 is made up of sensors that can be used in Internet of Things applications. For example, one sensor may be a thermometer and another sensor may be a motion detector.

Network module 517 is the collection of computer software, hardware, and firmware that allows classical computer 102 to communicate with other computers through WAN 113. Network module 517 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 517 are performed on the same physical hardware device. In other embodiments (for example, embodiments that utilize software-defined networking (SDN)), the control functions and the forwarding functions of network module 517 are performed on physically separate devices, such that the control functions manage several different network hardware devices. Computer readable program instructions for performing the inventive methods can typically be downloaded to classical computer 102 from an external computer or external storage device through a network adapter card or network interface included in network module 517.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 502 is any computer system that is used and controlled by an end user (for example, a customer of an enterprise that operates classical computer 102), and may take any of the forms discussed above in connection with classical computer 102. EUD 502 typically receives helpful and useful data from the operations of classical computer 102. For example, in a hypothetical case where classical computer 102 is designed to provide a recommendation to an end user, this recommendation would typically be communicated from network module 517 of classical computer 102 through WAN 113 to EUD 502. In this way, EUD 502 can display, or otherwise present, the recommendation to an end user. In some embodiments, EUD 502 may be a client device, such as thin client, heavy client, mainframe computer, desktop computer and so on.

Remote server 503 is any computer system that serves at least some data and/or functionality to classical computer 102. Remote server 503 may be controlled and used by the same entity that operates classical computer 102. Remote server 503 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 518 of remote server 503.

Public cloud 504 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 504 is performed by the computer hardware and/or software of cloud orchestration module 520. The computing resources provided by public cloud 504 are typically implemented by virtual computing environments that run on various computers making up the computers of host physical machine set 521, which is the universe of physical computers in and/or available to public cloud 504. The virtual computing environments (VCEs) typically take the form of virtual machines from virtual machine set 522 and/or containers from container set 523. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 519 is the collection of computer software, hardware, and firmware that allows public cloud 504 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 505 is similar to public cloud 504, except that the computing resources are only available for use by a single enterprise. While private cloud 505 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 504 and private cloud 505 are both part of a larger hybrid cloud.

Block 501 further includes the software components discussed above in connection with FIGS. 2-4 to reduce the number of shots required to perform a noisy circuit simulation. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for reducing the number of shots required to perform a noisy circuit, may be embodied in an application specific integrated circuit.

As stated above, quantum devices, such as quantum circuits, are susceptible to errors. In particular, the qubit measurement is among the most error-prone operations on quantum devices, with error rates ranging from 8% to 30% for current hardware. These errors arise from bit flips, i.e., from erroneously recording an outcome as 0 given it was actually 1, and vice-versa. The source of such errors arise from noise that occurs throughout a computation. Noise refers to the multiple factors that can affect the accuracy of the calculations a quantum computer performs. Quantum computers are susceptible to noise from various sources, such as disturbances in the Earth's magnetic field, local radiation from Wi-Fi or mobile phones, cosmic rays, and even the influence that neighboring qubits exert on each other by mere proximity. These disruptions cause the information an idle qubit holds to fade away. Lastly, whine performing a quantum logic operation, qubits can also suffer from errors that cause them to rotate by the wrong amount. In all cases, the final state of the quantum computer is not precisely the state one expects. Unless one can reverse the action of the noise, the information in the quantum system can become randomized or totally erased. This phenomenon is known as decoherence. As a result, noise models have been constructed to approximate the real behavior of the quantum device taking into consideration such noise effects, such as gate noise, readout noise, etc. Examples of such noise models include the Pauli noise and Kraus noise models. Subsequently, quantum circuits are simulated with noise models in order to consider the noise on the actual hardware or to understand the behavior of noisy hardware. Unfortunately, such noise models require simulations of a quantum circuit involving a large number of shots. A “shot” corresponds to one complete execution of a quantum circuit. A quantum circuit is a computational routine consisting of coherent quantum operations on quantum data, such as qubits. Simulations of a quantum circuit involving a large number of shots are required by such noise models as the calculated statevectors for each shot after completion of the shot are varied due to quantum errors. A “statevector” corresponds to a format of the state of probabilities (e.g., quantum state of 1 or quantum state of 0) for the qubits manipulated by the quantum logic gates of the quantum circuit. A “quantum logic gate” corresponds to a basic quantum circuit operating on a small number of qubits. Quantum logic gates are the building blocks of quantum circuits. Furthermore, intermediate measurements, which correspond to measurements taking during the shot, are used to evaluate a qubit state in the quantum circuit for branch operations. Such measurements also cause different results per shot due to noise. As a result, simulations involving intermediate measurements also require a large number of shots. By requiring simulations of a quantum circuit involving a large number of shots, such simulations require a large amount of computing time and computing resources.

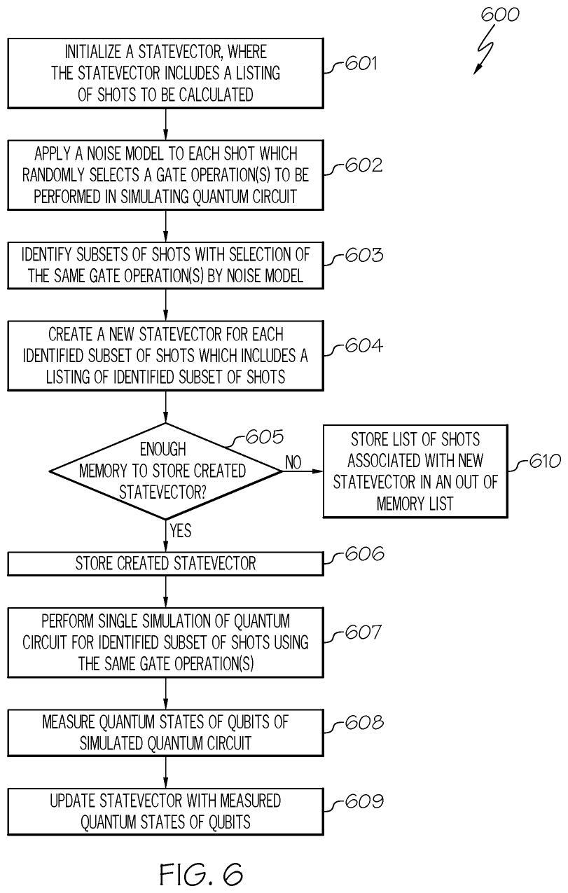

The embodiments of the present disclosure provide the means for reducing the number of shots required to perform a noisy circuit simulation by performing a single simulation of the quantum circuit for multiple shots using the same gate operation(s) selected by the noise model for such shots as discussed below in connection with FIG. 6.

FIG. 6 is a flowchart of a method 600 for reducing the number of shots required to perform a noisy circuit simulation in accordance with an embodiment of the present disclosure.

Referring to FIG. 6, in conjunction with FIGS. 1-5, in step 601, initialization engine 201 of classical computer 102 initializes a statevector 301 for the shots of a simulation of a quantum circuit, such as quantum circuit 109.

As discussed above, statevector 301 includes a listing of the shots to be calculated from simulating a quantum circuit, such as quantum circuit 109. A “statevector,” as used herein, refers to a vector that holds the information needed to describe the measured quantum state of a simulated quantum circuit. In one embodiment, the statevector holds such information for each particular shot. A “shot,” as used herein, corresponds to one complete execution of a quantum circuit. In one embodiment, when initialization engine 201 initializes the statevector, the statevector only includes a listing of the shots to be calculated, such as shot numbers 0 . . . n−1, where n is a positive integer number.

In one embodiment, initialization engine 201 initializes the statevector as discussed above using the class initialize in Qiskit®, in which the parameters of the statevector are initialized to include a listing of the shots to be calculated.

In step 602, noise model engine 202 of classical computer 102 applies a noise model 302 (e.g., Pauli noise model, Krause noise model) to each shot identified in the list of shots to be calculated discussed above. As discussed in further detail below, for each shot, noise model 302 randomly selects a gate operation(s) to be performed in simulating the quantum circuit, such as quantum circuit 109, for such a shot.

For example, noise models, such as the Pauli noise model and the Kraus noise model, select gate operations to be performed by the quantum circuit to be simulated. In one embodiment, such gate operations are randomly selected. For example, the Pauli noise model randomly selects particular quantum logic gates (e.g., identity (“ID”) gate and the Pauli gates (X, Y and Z gates)) to perform gate operations on the qubits of the simulated quantum circuit based on a probability table. It has been discovered that in a large number of cases, the identity gate is selected. When the same gate operations are performed by the same simulated quantum circuit, even for different shots, the simulated quantum circuit produces results (measured quantum states of the qubits of the simulated quantum circuit) that are relatively the same. Hence, the number of shots required to perform a noisy circuit simulation can be reduced by simulating a quantum circuit to perform the gate operations on the qubits of the quantum circuit for a single shot that represents other shots in cases where the noise model selects the same gate operations to be performed by the quantum circuit to be simulated for such shots.

Similarly, in another example, the Krause noise model selects matrix multiplications to be performed by the quantum circuit to be simulated based on a probability table. It has been discovered that in a large number of cases, the first matrix is selected, which is equivalent to the identity gate. Hence, as in the case with the Pauli noise model, the number of shots required to perform a noisy circuit simulation can be reduced by simulating a quantum circuit to perform the gate operations on the qubits of the quantum circuit for a single shot that represents other shots in cases where the noise model selects the same matrix multiplications (gate operations) to be performed by the quantum circuit to be simulated for such shots.

In one embodiment, noise model engine 202 applies such noise models to each shot identified in the list of shots to be calculated discussed above using various software tools, including, but not limited to, Cirq, QuTIP, Qiskit® Aer Simulator, etc.

In step 603, noise model engine 202 of classical computer 102 identifies the subsets of shots (e.g., shot numbers 1 and 3 in one set, shot numbers 5, 6 and 7 in another set, etc.) out of the listing of shots to be calculated, where each identified subset of shots has the same gate operation(s) selected by noise model 302 to be performed in simulating the quantum circuit, such as quantum circuit 109.

For example, shot numbers 1 and 3 may be identified as having the same gate operation (Pauli Z gate) selected by noise model 302 to be performed in simulating the quantum circuit. A single simulation of the quantum circuit, such as quantum circuit 109, would then be performed for such a subset of shots using the gate operation (e.g., Pauli Z gate) selected by noise model 302 for such a group of shots. Since the results (measured quantum states of the qubits of the simulated quantum circuit) in simulating the quantum circuit by performing the same gate operations, even for different shots, are relatively the same, the number of shot calculations can be reduced by only performing the gate operations on the qubits of the quantum circuit for a single shot that represents other shots in the same grouping of shots where noise model 302 selects the same gate operations to be performed by the quantum circuit to be simulated.

In one embodiment, noise model engine 202 identifies such subsets of shots (e.g., shot numbers 1 and 3 in one set, shot numbers 5, 6 and 7 in another set, etc.) out of the listing of shots to be calculated, where each identified subset of shots has the same gate operation(s) selected by the noise model to be performed in simulating the quantum circuit, such as quantum circuit 109, using various software tools, including, but not limited to, Qiskit® Aer Simulator, True-Q™, etc.

In step 604, creator engine 203 of classical computer 102 creates a new statevector 303 for each identified subset of shots. In one embodiment, such a created statevector 303 corresponds to a copy of the initialized statevector 301 except that the listing of shots corresponds to only those shot numbers in the identified subset of shots. For example, if noise model engine 202 identifies shot numbers 1 and 3 as having the same gate operation (Pauli Z gate) selected by noise model 302 to be performed in simulating the quantum circuit, then creator engine 203 creates a new statevector 303 for such a grouping of shots, where such a new statevector 303 includes a listing of shot numbers 1 and 3.

As stated above, initialization engine 201 initializes a statevector 301 with a listing of the shots (0 . . . , n−1), where n is a positive integer, to be calculated. Furthermore, as discussed above, noise model engine 202 applies a noise model, such as noise model 302 (e.g., Pauli noise model, Krause noise model), to each shot identified in the list of shots to be calculated. For each shot, noise model 302 selects a gate operation(s) to be performed in simulating the quantum circuit for such a shot.

For instance, as shown in FIG. 3, noise model engine 202 applies noise model 302 to each shot listed in the initialized statevector 301 where noise model 302 randomly selects a gate operation(s) to be performed in simulating the quantum circuit, such as quantum circuit 109.

As discussed above, noise model engine 202 identifies the subsets of shots (e.g., shot numbers 1 and 3 in one set, shot numbers 5, 6 and 7 in another set, etc.) out of the listing of shots to be calculated which have the same gate operation(s) selected by noise model 302 to be performed in simulating the quantum circuit, such as quantum circuit 109. For instance, as shown in FIG. 3, shot numbers 1 and 3 were identified by noise model engine 202 as having the same gate operation(s) (e.g., identity gate) selected by noise model 302 to be performed in simulating the quantum circuit, such as quantum circuit 109. As a result, a new statevector 303A is created by creator engine 203 copying statevector 301 and applying gate operations selected by noise model 302. As shown in FIG. 3, statevector 303A includes the listing of shot numbers 1 and 3. Such shots are known as “branched shots” since the listing of such shots are branched from the original listing of shots in the initialized statevector 301 as shown in FIG. 3. Furthermore, as a result of creating a new statevector, such as statevector 303A, for the branched shots (e.g., shot numbers 1 and 3), the original listing of shots in the initialized statevector 301 is updated to reflect that a portion of the shots in the original listing of shots have been branched, such as removing such shots from the original listing of shots as shown in statevector 301′ (updated statevector 301 of FIG. 3).

Furthermore, FIG. 3 illustrates other branched shots, such as shot number 2 and shot number 4. For instance, noise model engine 202 identifies shot number 2 out of the listing of shots to be calculated as corresponding to the only shot in which a particular gate operation (e.g., Pauli X gate) was selected by noise model 302′ (same as noise model 302) to be performed in simulating the quantum circuit, such as quantum circuit 109. In such a case, a new statevector 303B is created by creator engine 203 which includes the listing of shot number 2. In another example, noise model engine 202 identifies shot number 4 out of the listing of shots to be calculated as corresponding to the only shot in which a particular gate operation (e.g., Pauli Y gate) was selected by noise model 302′ (same as noise model 302) to be performed in simulating the quantum circuit, such as quantum circuit 109. In such a case, a new statevector 303C is created by creator engine 203 which includes the listing of shot number 4.

As a result of creating statevectors 303B, 303C for the branched shots (e.g., shot numbers 2 and 4, respectively), the original listing of shots in the initialized statevector 301 is updated to reflect that a portion of the shot numbers in the original listing of shots have been branched, such as removing such shots from the original listing of shots as shown in statevector 301″ (updated statevector 301′ of FIG. 3).

New statevectors, such as statevectors 303A-303E, are created for each unique gate operation(s) (including a set of gate operations) selected by noise model 302 for the shot(s) associated with such statevectors 303.

As a result of such branched shots, the initialized statevector 301 is updated to reflect those particular shot numbers in the original listing of shots that have been branched, such as removing such shots from the original listing of shots as shown in statevector 301′″, which reflects the final listing of shots for the original initialized statevector 301.

In step 605, creator engine 203 of classical computer 102 determines whether there is enough memory in classical computer 102 to store the created statevector(s) 303. If there is enough memory in classical computer 102 to store such created statevector(s) 303, then, in step 606, creator engine 203 of classical computer 102 stores such created statevector(s) in memory (e.g., persistent storage 511) of classical computer 102.

In step 607, upon storing the created statevector(s) 303, such as statevector 303A, simulator 204 of classical computer 102 performs a single simulation of the quantum circuit, such as quantum circuit 109, for the identified subset of shots using the same gate operation(s) selected by noise model 302 for such shots. For example, simulator 204 may simulate the quantum circuit, such as quantum circuit 109, using the same gate operation(s) selected by noise model 302″″ (same as noise model 302) for each of the identified subset of shots (e.g., shot numbers 1 and 3).

In one embodiment, examples of simulator 204 performing such a simulation, include, but not limited to, Qiskit® Aer simulator, IQS, staq, QuEST®, QX Simulator, QMDD, CHP, etc.

In step 608, simulator 204 of classical computer 102 measures the quantum states of the qubits of the simulated quantum circuit for the identified subset of shots after performing the single simulation. Such measured quantum states of the qubits are later stored in the statevector 303 (e.g., statevector 303A) associated with such a subset of shots by updating such a statevector 303 to include the measured quantum states of the qubits of the simulated quantum circuit.

In one embodiment, simulator 204 measures the quantum states of the qubits of the simulated quantum circuit, such as quantum circuit 109, for multiple branched shots concurrently, which improves efficiency of kernel execution.

Furthermore, in one embodiment, by simulator 204 measuring the quantum states of the qubits of the simulated quantum circuit, such as quantum circuit 109, for branched shots, intermediate measurements may be handled. For example, intermediate measurements may be used to evaluate a qubit state in the quantum circuit, such as quantum circuit 109, for branch operations that also cause a different result per shot.

In one embodiment, examples of simulator 204 measuring the quantum states of the qubits of the simulated quantum circuit, include, but not limited to, Qiskit® Aer simulator, IQS, staq, QuEST®, QX Simulator, QMDD, CUP, etc.

Upon measuring the quantum state of the qubits of the simulated quantum circuit, such as quantum circuit 109, for the identified subset of shots, in step 609, simulator 204 of classical computer 102 updates statevector 303 associated with the identified subset of shots (e.g., shot numbers 1 and 3) with the measured quantum states of the qubits of the simulated quantum circuit, such as quantum circuit 109. For example, statevector 303 (e.g., statevector 303A) with the listing of shot numbers 1 and 3 would also include the measured quantum states (e.g., 0 or 1) for the various qubits (e.g., qubits 0-9) of the simulated quantum circuit, such as quantum circuit 109, for shot numbers 1 and 3.

In one embodiment, examples of simulator 204 performing such functions, include, but not limited to, Qiskit® Aer simulator, IQS, staq, QuEST®, QX Simulator, QMDD, CHP, etc.

Conventional simulations using a noise model, such as noise model 302, require n statevector updates for n shot simulations in which n shots are measured independently. However, using the principles of the present disclosure, fewer than n shots need to be measured since a subset of the n shots may be grouped together to be associated with a single statevector, such as statevector 303, which includes a single simulation result (measured quantum states of the qubits of the simulated quantum circuit) applicable to all such grouped shots.

Returning to step 605, if, however, there is not enough memory in classical computer 102 to store such created statevector(s) 303, then, in step 610, creator engine 203 of classical computer 102 stores the listing of shots associated with such a created statevector(s) 303 in an out of memory list, such as in a storage device (e.g., storage device 511, 515) of classical computer 102.

For example, as discussed above, referring to FIG. 4, noise model engine 202 identifies shot numbers 5, 10, 12 . . . out of the listing of shots to be calculated as corresponding to those shots in which a particular gate operation (e.g., Pauli Z gate) was selected by noise model 302″ (same as noise model 302) to be performed in simulating the quantum circuit, such as quantum circuit 109. In such a case, a new statevector 303D is created by creator engine 203 which includes the listing of shot numbers 5, 10, 12, etc. In such a case, however, there is not enough memory to store such a statevector. Hence, creator engine 203 stores a listing of the shots 401 associated with statevector 303D in an out of memory list, such as in a storage device (e.g., storage device 511, 515) of classical computer 102. Upon storing such a listing of shots 401 in an out of memory list, the original listing of shots in the initialized statevector 301 is updated to reflect that a portion of the shots in the original listing of shots have been branched, such as removing shots 5, 10, 12, etc. from the original listing of shots as shown in statevector 402.

In one embodiment, when there is enough memory to store such newly created statevectors 303 (e.g., statevector 303D), the process discussed above is performed in the same manner except that the initialized statevector 301 corresponds to the listing of shots in listing 401. That is, listing 401 corresponds to a statevector with a listing of shots to be calculated. The process then proceeds as discussed above, such as applying noise model 302′″ (same as noise model 302) to each shot in listing 401, which results in noise model engine 202 identifying shot number 10 out of the listing of shots in listing 401 to be the only shot out of the shots listed in listing 401 in which a particular gate operation (e.g., Pauli X gate) was selected by noise model 302′″ to be performed in simulating the quantum circuit, such as quantum circuit 109. In such a case, a new statevector 303E is created by creator engine 203 which includes the listing of shot number 10. As a result of creating statevector 303E for the branched shot (e.g., shot number 10), the original listing 401 is updated to reflect that a portion of the shots in the original listing has been branched, such as removing such a shot from the original listing of shots as shown in listing 401′ (updated listing 401 of FIG. 4).

As a result of the foregoing, the principles of the present disclosure provide a means for reducing the number of shots required to perform a noisy circuit simulation by performing a single simulation of the quantum circuit for multiple shots using the same gate operation(s) selected by the noise model for such shots. Since the results (measured quantum states of the qubits of the simulated quantum circuit) in simulating the quantum circuit by performing the same gate operations, even for different shots, are relatively the same, the number of shot calculations can be reduced by only performing the gate operations on the qubits of the quantum circuit for a single shot that represents other shots in the same grouping of shots where the noise model selects the same gate operations to be performed by the quantum circuit to be simulated.

Furthermore, the principles of the present disclosure improve the technology or technical field involving noisy circuit simulations in quantum computing.

As discussed above, quantum devices, such as quantum circuits, are susceptible to errors. In particular, the qubit measurement is among the most error-prone operations on quantum devices, with error rates ranging from 8% to 30% for current hardware. These errors arise from bit flips, i.e., from erroneously recording an outcome as 0 given it was actually 1, and vice-versa. The source of such errors arise from noise that occurs throughout a computation. Noise refers to the multiple factors that can affect the accuracy of the calculations a quantum computer performs. Quantum computers are susceptible to noise from various sources, such as disturbances in the Earth's magnetic field, local radiation from Wi-Fi or mobile phones, cosmic rays, and even the influence that neighboring qubits exert on each other by mere proximity. These disruptions cause the information an idle qubit holds to fade away. Lastly, when performing a quantum logic operation, qubits can also suffer from errors that cause them to rotate by the wrong amount. In all cases, the final state of the quantum computer is not precisely the state one expects. Unless one can reverse the action of the noise, the information in the quantum system can become randomized or totally erased. This phenomenon is known as decoherence. As a result, noise models have been constructed to approximate the real behavior of the quantum device taking into consideration such noise effects, such as gate noise, readout noise, etc. Examples of such noise models include the Pauli noise and Kraus noise models. Subsequently, quantum circuits are simulated with noise models in order to consider the noise on the actual hardware or to understand the behavior of noisy hardware. Unfortunately, such noise models require simulations of a quantum circuit involving a large number of shots. A “shot” corresponds to one complete execution of a quantum circuit. A quantum circuit is a computational routine consisting of coherent quantum operations on quantum data, such as qubits. Simulations of a quantum circuit involving a large number of shots are required by such noise models as the calculated statevectors for each shot after completion of the shot are varied due to quantum errors. A “statevector” corresponds to a format of the state of probabilities (e.g., quantum state of 1 or quantum state of 0) for the qubits manipulated by the quantum logic gates of the quantum circuit. A “quantum logic gate” corresponds to a basic quantum circuit operating on a small number of qubits. Quantum logic gates are the building blocks of quantum circuits. Furthermore, intermediate measurements, which correspond to measurements taking during the shot, are used to evaluate a qubit state in the quantum circuit for branch operations. Such measurements also cause different results per shot due to noise. As a result, simulations involving intermediate measurements also require a large number of shots. By requiring simulations of a quantum circuit involving a large number of shots, such simulations require a large amount of computing time and computing resources.

Embodiments of the present disclosure improve such technology by applying a noise model, such as the Pauli noise model or the Kraus noise model, to each shot of the quantum circuit to be simulated, where the noise model randomly selects a gate operation to be performed in simulating the quantum circuit. A “shot,” as used herein, corresponds to one complete execution of a quantum circuit. For example, the Pauli noise model randomly selects particular quantum logic gates (e.g., identity (“ID”) gate and the Pauli gates (X, Y and Z gates)) to perform gate operations on the qubits of the simulated quantum circuit based on a probability table. It has been discovered that in a large number of cases, the identity gate is selected. When the same gate operations are performed by the same simulated quantum circuit, even for different shots, the simulated quantum circuit produces results (measured quantum states of the qubits of the simulated quantum circuit) that are relatively the same. Hence, the number of shots required to perform a noisy circuit simulation can be reduced by simulating a quantum circuit to perform the gate operations on the qubits of the quantum circuit for a single shot that represents other shots in cases where the noise model selects the same gate operations to be performed by the simulated quantum circuit for such shots. Similarly, in another example, the Krause noise model selects matrix multiplications to be performed by the simulated quantum circuit based on a probability table. It has been discovered that in a large number of cases, the first matrix is selected, which is equivalent to the identity gate. Hence, as in the case with the Pauli noise model, the number of shots required to perform a noisy circuit simulation can be reduced by simulating a quantum circuit to perform the gate operations on the qubits of the quantum circuit for a single shot that represents other shots in cases where the noise model selects the same matrix multiplications (gate operations) to be performed by the simulated quantum circuit for such shots. In one embodiment, a subset of shots are identified, where each of the identified subset of shots has the same gate operation(s) selected by the noise model to be performed in simulating the quantum circuit. For example, shot numbers 1 and 3 may be identified as having the same gate operation (Pauli Z gate) selected by the noise model to be performed in simulating the quantum circuit. A single simulation of the quantum circuit would then be performed for such a subset of shots using the gate operation (e.g., Pauli Z gate) selected by the noise model for such a group of shots. Since the results (measured quantum states of the qubits of the simulated quantum circuit) in simulating the quantum circuit by performing the same gate operations, even for different shots, are relatively the same, the number of shot calculations can be reduced by only performing the gate operations on the qubits of the quantum circuit for a single shot that represents other shots in the same grouping of shots where the noise model selects the same gate operations to be performed by the quantum circuit to be simulated. In this manner, the number of shots required to perform a noisy circuit simulation is reduced. Furthermore, in this manner, there is an improvement in the technical field involving noisy circuit simulations in quantum computing.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for reducing a number of shots required to perform a noisy circuit simulation, the method comprising:
applying a noise model to each shot of a plurality of shots of a quantum circuit which randomly selects a gate operation to be performed in simulating said quantum circuit;
identifying a subset of said plurality of shots with a selection of a same gate operation; and
performing a single simulation of said quantum circuit for said identified subset of said plurality of shots using said same gate operation.

2. The method as recited in claim 1, wherein a plurality of subsets of said plurality of shots are identified, wherein each of said plurality of subsets of said plurality of shots utilizes a different gate operation selected by said noise model.

3. The method as recited in claim 1 further comprising:
measuring quantum states of qubits of said simulated quantum circuit for said identified subset of said plurality of shots after performing said single simulation; and
updating a statevector with said measured quantum states of qubits of said simulated quantum circuit.

4. The method as recited in claim 1 further comprising:
initializing a statevector for said plurality of shots of said quantum circuit; and
creating a new statevector for said identified subset of said plurality of shots.

5. The method as recited in claim 4, wherein said new statevector comprises a copy of said initialized statevector, wherein said new statevector comprises a listing of said identified subset of said plurality of shots.

6. The method as recited in claim 5 further comprising:
measuring quantum states of qubits of said simulated quantum circuit for said identified subset of said plurality of shots after performing said single simulation; and
updating said new statevector with said measured quantum states of qubits of said simulated quantum circuit.

7. The method as recited in claim 4 further comprising:
storing a list of shots comprising said identified subset of said plurality of shots in an out of memory list in response to a lack of memory for storing said created new statevector.

8. A computer program product for reducing a number of shots required to perform a noisy circuit simulation, the computer program product comprising one or more computer readable storage mediums having program code embodied therewith, the program code comprising programming instructions for:
applying a noise model to each shot of a plurality of shots of a quantum circuit which randomly selects a gate operation to be performed in simulating said quantum circuit;
identifying a subset of said plurality of shots with a selection of a same gate operation; and
performing a single simulation of said quantum circuit for said identified subset of said plurality of shots using said same gate operation.

9. The computer program product as recited in claim 8, wherein a plurality of subsets of said plurality of shots are identified, wherein each of said plurality of subsets of said plurality of shots utilizes a different gate operation selected by said noise model.

10. The computer program product as recited in claim 8, wherein the program code further comprises the programming instructions for:
measuring quantum states of qubits of said simulated quantum circuit for said identified subset of said plurality of shots after performing said single simulation; and
updating a statevector with said measured quantum states of qubits of said simulated quantum circuit.

11. The computer program product as recited in claim 8, wherein the program code further comprises the programming instructions for:
initializing a statevector for said plurality of shots of said quantum circuit; and
creating a new statevector for said identified subset of said plurality of shots.

12. The computer program product as recited in claim 11, wherein said new statevector comprises a copy of said initialized statevector, wherein said new statevector comprises a listing of said identified subset of said plurality of shots.

13. The computer program product as recited in claim 12, wherein the program code further comprises the programming instructions for:
measuring quantum states of qubits of said simulated quantum circuit for said identified subset of said plurality of shots after performing said single simulation; and
updating said new statevector with said measured quantum states of qubits of said simulated quantum circuit.

14. The computer program product as recited in claim 11, wherein the program code further comprises the programming instructions for:
storing a list of shots comprising said identified subset of said plurality of shots in an out of memory list in response to a lack of memory for storing said created new statevector.

15. A system, comprising:
a memory for storing a computer program for reducing a number of shots required to perform a noisy circuit simulation; and
a processor connected to said memory, wherein said processor is configured to execute program instructions of the computer program comprising:
applying a noise model to each shot of a plurality of shots of a quantum circuit which randomly selects a gate operation to be performed in simulating said quantum circuit;
identifying a subset of said plurality of shots with a selection of a same gate operation; and
performing a single simulation of said quantum circuit for said identified subset of said plurality of shots using said same gate operation.

16. The system as recited in claim 15, wherein a plurality of subsets of said plurality of shots are identified, wherein each of said plurality of subsets of said plurality of shots utilizes a different gate operation selected by said noise model.

17. The system as recited in claim 15, wherein the program instructions of the computer program further comprise:
measuring quantum states of qubits of said simulated quantum circuit for said identified subset of said plurality of shots after performing said single simulation; and
updating a statevector with said measured quantum states of qubits of said simulated quantum circuit.

18. The system as recited in claim 15, wherein the program instructions of the computer program further comprise:
initializing a statevector for said plurality of shots of said quantum circuit; and
creating a new statevector for said identified subset of said plurality of shots.

19. The system as recited in claim 18, wherein said new statevector comprises a copy of said initialized statevector, wherein said new statevector comprises a listing of said identified subset of said plurality of shots.

20. The system as recited in claim 19, wherein the program instructions of the computer program further comprise:
measuring quantum states of qubits of said simulated quantum circuit for said identified subset of said plurality of shots after performing said single simulation; and
updating said new statevector with said measured quantum states of qubits of said simulated quantum circuit.
